(19) United States
(12) Patent Application Publication
(10) Pub. No.: US 2022/0410429 A1
(43) Pub. Date: Dec. 29, 2022

(54) Curing chamber for building materials

(71) Applicant: Robert Thomas Metall- und Elektrowerke GmbH & Co. KG, Neunkirchen (DE)

(72) Inventor: Erik LEU, Kirchen-Freusburg (DE)

(73) Assignee: Robert Thomas Metall- und Elektrowerke GmbH & Co. KG, Neunkirchen (DE)

(21) Appl. No.: 17/846,657

(22) Filed: Jun. 22, 2022

(30) Foreign Application Priority Data
Jun. 24, 2021 (DE) 10 2021 003 243.8

(51) Int. Cl. B28B 11/24

(52) U.S. Cl. CPC B28B 11/245; B28B 11/247; B28B 11/248

(57) ABSTRACT

A chamber (1) for hardening building materials comprises sheet metal elements which are insulated from one another and are built on a base plate (5) and which form walls (2) and a ceiling (3). The chamber can be manufactured and operated inexpensively and is suitable both as a curing chamber for concrete blocks and for building materials cured with CO₂. To this end, it is proposed that the walls (2) and/or ceiling (3) consist of self-supporting, double-walled sheet metal elements (4) connected to one another in an essentially gas-tight manner, and that the double-walled sheet metal elements (4) of the supply and/or discharge and distribution a gaseous hardening medium from outside the chamber (1) into its interior.

### CROSS-REFERENCE TO RELATED APPLICATION

This application claims the benefit of German Patent Application No. 10 2021 003 243.8, filed 2021 Jun. 24, the contents of which is incorporated by reference in its entirety.

### TECHNICAL FIELD

The disclosure relates to a chamber for curing building materials. The chamber comprises sheet metal elements which are built on a base plate, insulated from one another, and form walls and a ceiling.

### BACKGROUND

Curing chambers are generally known for drying bricks. Chambers for curing concrete blocks have rack systems made up of several rack supports and several support elements arranged on the rack supports for supporting shelves on which the concrete masses to be hardened are stored. Air, adjusted in its temperature and humidity, is fed through duct systems to the concrete masses to be cured. In some cases, the supply air duct system can be integrated into the rack system. Another complex exhaust air duct system, which can also be partially integrated into the rack system, serves to ensure a corresponding flow.

### SUMMARY

The disclosure provides a cost-effective curing chamber suitable both for concrete blocks and for building materials cured by CO₂.

In a chamber of this type, the walls and/or ceiling consist of self-supporting, double-walled sheet metal elements connected to one another in an essentially gas-tight manner. The double-walled sheet metal elements supply and/or discharge and distribute a gaseous curing medium from outside the chamber in its interior.

The self-supporting sheet metal elements eliminate the need for complex rack systems. Due to the double-walled sheet metal elements, the gas supply and the gas discharge is considerably simplified and made more economical.

Advantageously, air with defined, predeterminable temperature and humidity conditions can be used in the chamber air as the gaseous curing medium for curing of concrete. Alternatively, CO₂ can be used as the gaseous hardening medium for curing building materials.

The walls and/or ceiling are formed self-supporting from several trough-shaped sheet metal elements. Those consist of a base area, side walls bent on all sides and edge strips bent inwards opposite these and running essentially parallel to the base area. Metal panels are arranged in the so formed interior area of the double walls and/or double ceilings of the chamber in a substantially gas-tight manner on the edge strips. Edge joints are firmly and substantially gas-tightly connected to one another. The sheet metal elements with their base area standing in a common plane are held together by their side walls via connections bracing seals. Sheet metal elements that adjoin at right angles are held by side walls bracing connections via seals with edge strips and sheet metal panels arranged thereon. The double walls and/or double ceilings have a media inlet and/or media outlet. The metal panels are assigned support elements for bracing supports for the building materials. The metal panels have media inlets and/or media outlets directed into the chamber.

To ensure tightness and stability, it has proven useful for the connections between the joints of the side walls and the edge strips of the trough-shaped sheet metal elements to be formed by a weld seam.

It is expedient for self-adhesive sealing strips and/or pasty sealants to be used circumferentially and/or continuously as seals. If, for example, silicone is used as a pasty sealant, subsequent insulation is possible without having to pay attention to whether the sealing strips might be damaged when assembling the chamber.

So that the ceiling can be walked on without any problems, it is expedient for trough-shaped sheet metal elements and/or sheet metal panels intended for ceilings to be made of sheet metal of greater thickness and/or a material of greater strength than the trough-shaped sheet metal elements and/or sheet metal panels intended for walls and/or have wider side walls and/or edge strips.

For the thermal insulation of the outer walls of the chamber, it is proposed that walls formed by base surfaces of trough-shaped sheet metal elements are assigned claddings provided at distances of the thickness of insulating packings, with the cladding being made of trapezoidal sheet metal.

For the thermal insulation of the ceiling, it has proven useful for the ceiling formed by bases of trough-shaped sheet metal elements to be assigned claddings at distances of the thickness of horizontal insulating layers, with perforated metal sheets being able to be provided as cladding.

To thermally insulate the sheet metal elements from one another, it is advantageous for the spaces between the bases of opposing trough-shaped sheet metal elements or the spaces formed between by the bases of the trough-shaped sheet metal elements and the cladding to be filled with pourable insulating material and/or insulating plates.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows a curing chamber in a partial cross-sectional perspective view.

FIG. 2 shows a partially sectioned portion of the chamber in a side view.

FIG. 3 shows a portion of the chamber in a perspective view.

FIG. 4 shows a double-walled sheet metal element.

FIG. 5 shows a detailed portion of a wall.

FIG. 6 is an enlarged detailed view of FIG. 2.

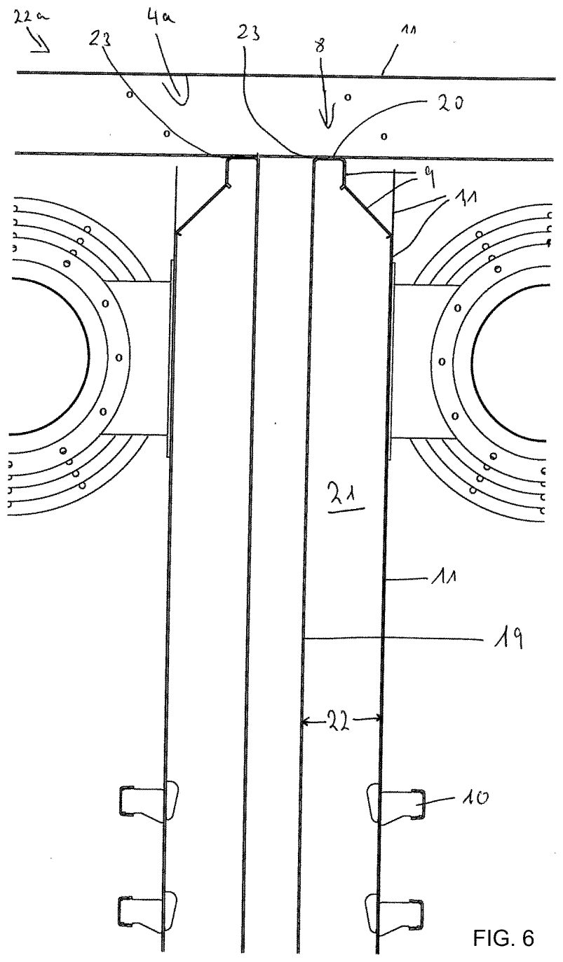

### DETAILED DESCRIPTION

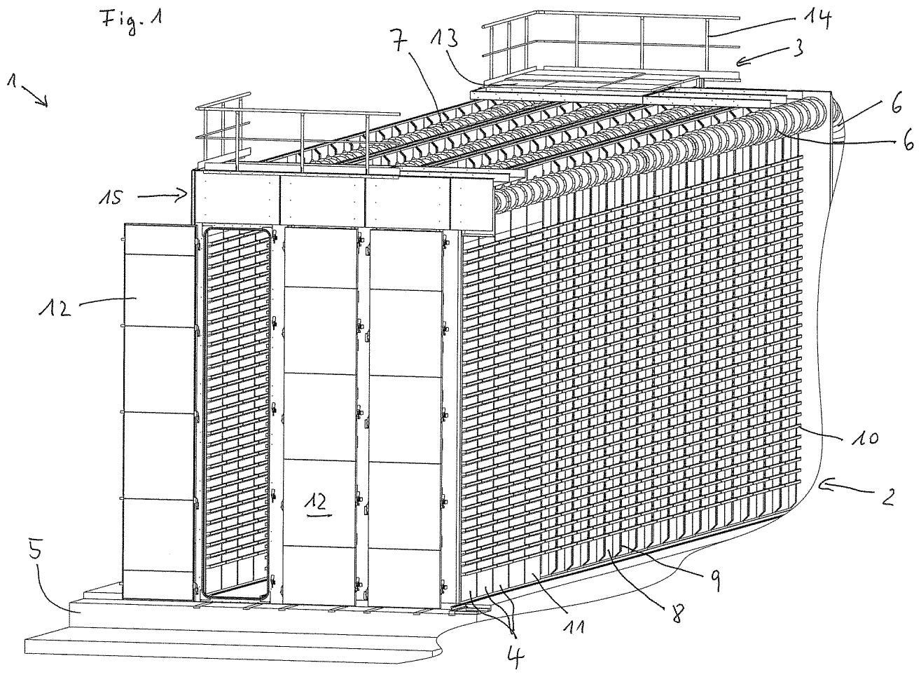

FIG. 1 shows a chamber 1, shown partially broken away, which has walls 2 and a ceiling 3. The walls 2 consist of a plurality of double-walled sheet metal elements 4 which may be screwed to one another and stand on a base plate 5. At the upper end, the standing double-walled sheet metal elements 4 of the walls 2 are connected to a media inlet 6. Here, the media inlet 6 is a duct system which feeds the individual double-walled sheet metal elements 4 with a gaseous medium. An opposite wall 2′ is connected to a media outlet 7, through which the gaseous medium can be sucked off. This can create a gas flow between opposite walls, which serves to cure the building materials.

Each double-walled sheet metal element 4 consists of a trough-shaped sheet metal element 8 with side walls bent on all sides and opposite these inwardly bent edge strips 9 running essentially parallel to the base surface of the trough-shaped sheet metal element 8. The joints of the side walls and edge strips 9 of the trough-shaped sheet metal elements 8 are connected with each other gas-tight by a welded seam. This weld also increases the stability of each individual trough-shaped sheet metal element 8.

Support elements 10 are screwed, welded or hung onto the edge strips 9. The support elements 10 are used to support carriers, not shown, for the building materials. The edge strips 9 are designed so large that between the docking points for the support elements 10 on one side of each trough-shaped sheet metal element 8 and the docking points for the support elements 10 on the opposite side of each trough-shaped sheet metal element 8 sheet metal panels 11 are screwed on in a substantially gas-tight manner. The sheet metal panels 11, which lie behind the support elements, have openings, holes or nozzles through which the building materials can be blasted with gas in a targeted manner or through which the gas is sucked back into the double-walled sheet metal panels, depending on whether the double-walled sheet metal elements 4 are connected to a media inlet 6 or a media outlet 7.

The chamber 1 has a plurality of doors 12, through which the contents for the chamber 1 can be introduced. On the ceiling 3 double-walled sheet metal elements 13 are also provided. The chamber has a railing 14 on the ceiling 3 for fall protection.

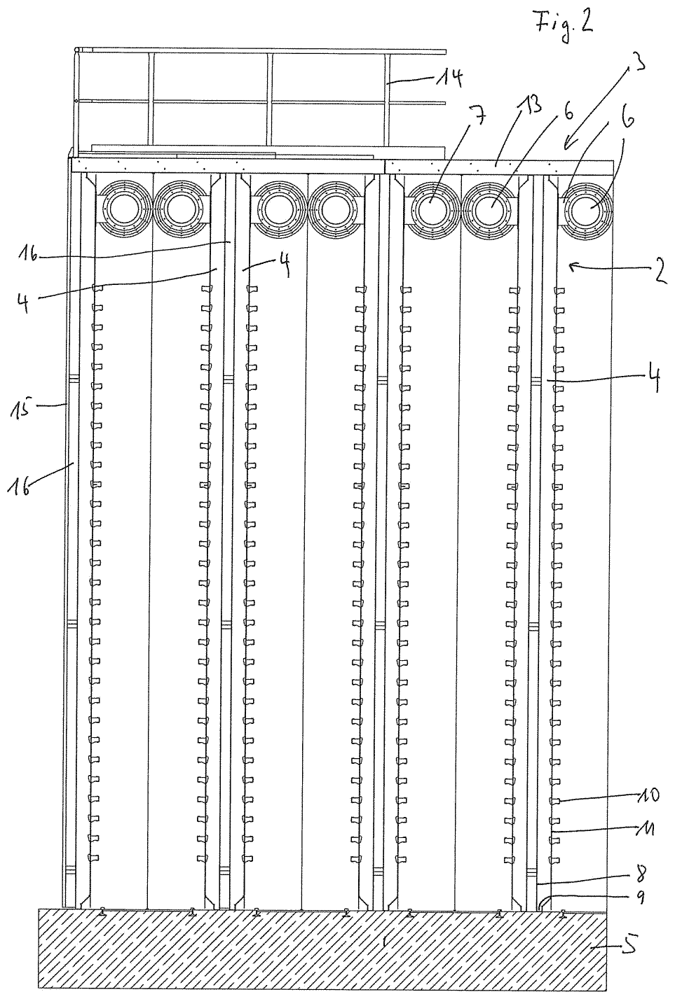

FIG. 2 shows walls 2 erected on the base plate 5. The wall 2 shown on the left in FIG. 2 is an outer wall consisting of a trapezoidal sheet metal 15, an insulation 16 and the double-walled sheet metal elements 4. The inner walls consist of the double-walled sheet metal elements 4, insulation 16, and subsequent double-walled sheet metal elements 4. At the upper end of FIG. 2 it can be seen that the double-walled sheet metal elements 4 are connected to media inlets 6 and media outlets 7. The double-walled sheet metal elements 4 each consist of a trough-shaped sheet metal element 8 with edges bent over in a C-shape. The sheet metal panels 11 are placed on the respective edge strips 9 of the trough-shaped sheet metal elements 8. Furthermore, the edge strips 9 hold the support elements 10.

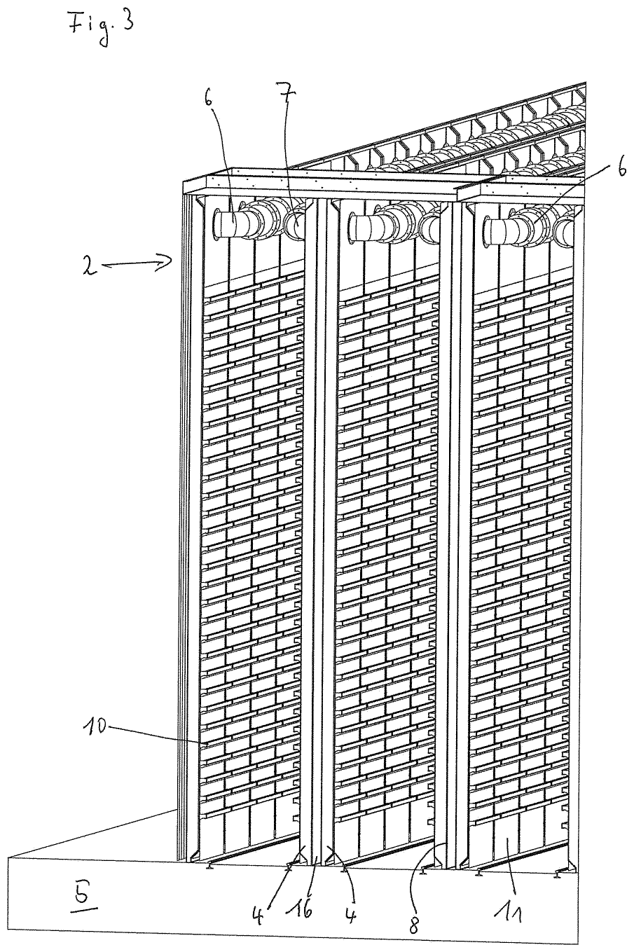

FIG. 3 shows a detail according to FIG. 2 in perspective view. Here, too, trough-shaped elements 8, the sheet metal panels 11 and the support elements 10 can be seen. The insulation 16 is also shown.

At the upper end of the walls 2, the double-walled sheet metal elements are provided with media inlets 6 and media outlets 7, respectively. There is the possibility that not every double-walled sheet metal element 4 of a wall 2 is equipped with a connection for the gas, but that for example only every second double-walled sheet metal element 4 is supplied with corresponding gases or that gases are drawn off only through every second double-walled sheet metal element 4. In this case, an offset of a double-walled sheet metal element 4 can be provided between the media inlet 6 on the one side and the media outlet 7 on the other side so that the gases flow obliquely through the chamber 1 from a media inlet 6 to the offset media outlet 7.

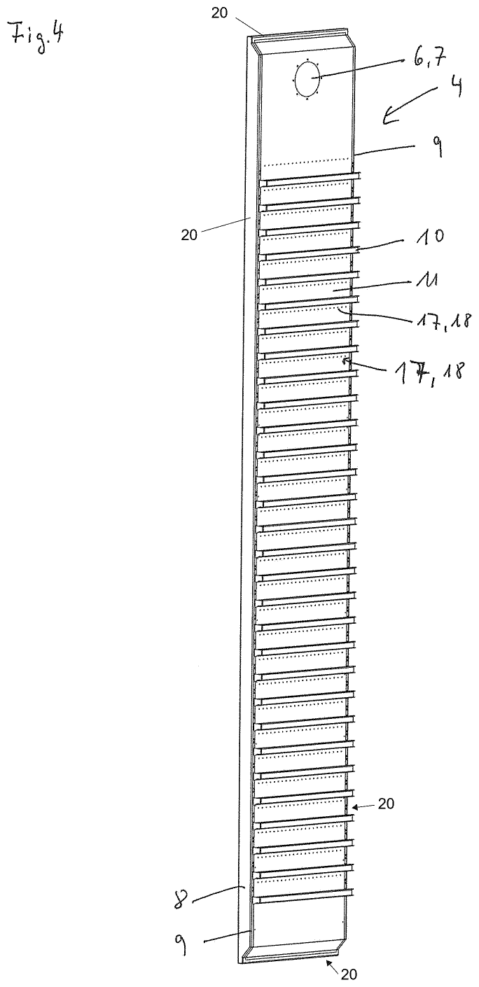

FIG. 4 shows a double-walled sheet metal element 4 consisting of a trough-shaped sheet metal element 8 in whose edge strips 9 support elements 10 are suspended. The trough-shaped sheet metal element 8 is closed by the sheet metal panel 11. The media inlet 6 or media outlet 7 is shown in the upper area of the sheet metal panel 11. The sheet metal panel 11 has a large number of openings as media inlets 17 or media outlets 18 through which the gas can flow to the building materials or through which the gas can be sucked into the double-walled sheet metal elements 4.

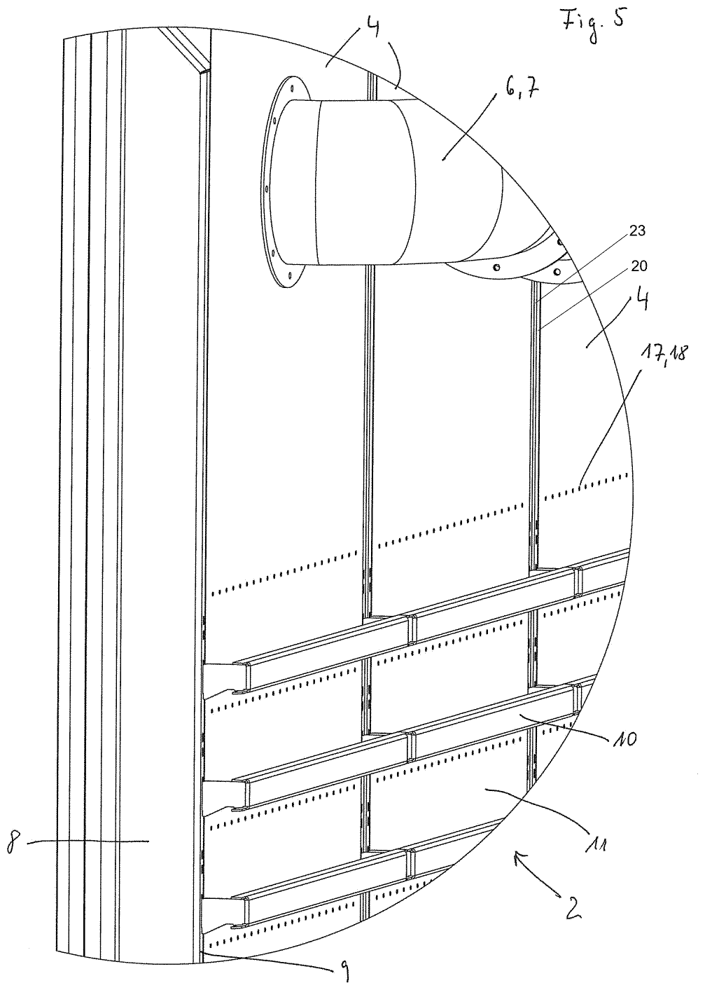

FIG. 5 shows several interconnected double-walled sheet metal elements 4 of a wall 2. The support elements 10 hooked into the edge strips 9 and the metal panels 11 with their media inlets 17 or media outlets 18 can be seen here.

The words “example” and “exemplary” as used herein mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

### REFERENCE NUMBERS OVERVIEW

1 chamber
2 wall
3 ceiling
4 double-walled sheet metal elements
5 base plate
6 media inlet
7 media outlet
8 trough-shaped sheet metal element
9 edge strips
10 support element
11 metal panel
12 doors
13 double-walled sheet metal elements
14 railings
15 trapezoidal sheets
16 insulation
17 media inlets
18 media outlets
19 base area
20 side walls
21 inner area
22 double walls
22a double ceiling
23 seals

What is claimed is:

1. A chamber (1) for curing building materials, the chamber (1) comprising:
a base plate (5);
a plurality of self-supporting, double-walled sheet metal elements (4) which are insulated from one another and are built on the base plate (5) to form walls (2) and a ceiling (3),
wherein the sheet metal elements (4) are connected to one another in an essentially gas-tight manner, and
wherein the sheet metal elements (4) supply a gaseous curing medium from outside the chamber (1) into the chamber (1) or discharge the gaseous curing medium from inside the chamber (1) to outside the chamber (1).

2. The chamber (1) according to claim 1,
wherein the curing medium is air with defined, predeterminable temperature and humidity conditions for curing concrete.

3. The chamber (1) according to claim 1,
wherein the curing medium is CO₂ to cure the building materials.

4. The chamber (1) according to claim 1,
wherein the walls (2) or the ceiling (3) are formed self-supporting from several trough-shaped sheet metal elements (8), which comprise
a base area (19),
side walls (20) bent on all sides, and
edge strips (9) of the trough-shaped sheet metal elements (8) that are bent inwards opposite the side walls and running essentially parallel to the base area (19),
wherein sheet metal panels (11) are arranged in a substantially gas-tight manner on the edge strips (9) forming an inner area (21) of double walls (22) and/or double ceilings (22a) of the chamber (1),
wherein the edge strips (9) are fixed and substantially gas-tight connected to one another are,
wherein sheet metal elements (8) standing in a common plane with their base are held together by their side walls (20) via seals (23) bracing connections,
wherein sheet metal elements (4a) adjoining at right angles are held by side walls (20) via seals (23) bracing connections with edge strips and metal panels (11) arranged thereon,
wherein the double walls (22) and/or double ceilings (22a) comprise a media inlet (6) or media outlet (7),
wherein the metal panels (11) or edge strips (9) are assigned support elements (10) for bracing supports for the building materials, and
wherein the metal panels (11) have media inlets (17) directed into the chamber (1) or media outlets (18).

5. The chamber (1) according to claim 4,
wherein connections of the side walls and the edge strips (9) of the trough-shaped sheet metal elements (8) are formed by a weld seam.

6. The chamber (1) according to claim 4,
wherein self-adhesive sealing strips and/or pasty sealants are used circumferentially and/or continuously as seals.

7. The chamber (1) according to claim 4,
wherein trough-shaped sheet metal elements (8) or sheet metal panels (11) provided for ceilings (3) are made of sheet metal of greater thickness or a material of higher strength than the trough-shaped sheet metal elements (8) or metal panels (11) provided for walls (2) or have wider side walls or edge strips (9).

8. The chamber (1) according to claim 4,
wherein walls (2) formed by bases of trough-shaped sheet metal elements (8) are associated with claddings provided at distances of a thickness of insulating packs (16).

9. The chamber (1) according to claim 8,
wherein the cladding is made of trapezoidal sheets (15).

10. The chamber (1) according to claim 4,
wherein the ceiling (3) formed by the bases of trough-shaped sheet metal elements (8) is assigned claddings at distances of a thickness of horizontal insulating layers.

11. The chamber (1) according to claim 10,
wherein perforated sheets are provided as cladding.

12. The chamber (1) according to claim 8,
wherein gaps formed between the bases of opposite trough-shaped sheet metal elements (8) or between the bases of the trough-shaped sheet metal elements (8) and the cladding are filled with pourable insulating material or insulating plates.
